(19) United States
(12) Patent Application Publication
(10) Pub. No.: US 2021/0344254 A1
(43) Pub. Date: Nov. 4, 2021

(54) MOTOR STRUCTURE

(71) Applicant: TECHWAY INDUSTRIAL CO.,LTD., Taichung City (TW)

(72) Inventors: FU-HSIANG CHUNG, Taichung City (TW); SHIH-WEI HUNG, Taichung City (TW); YU-CHIN LIN, Taichung City (TW); WEI-LIN HSU, Taichung City (TW)

(21) Appl. No.: 17/237,020

(22) Filed: Apr. 21, 2021

(30) Foreign Application Priority Data
Apr. 30, 2020 (TW) 109114613

(51) Int. Cl. H02K 9/22; H02K 1/14; H02K 11/25

(52) U.S. Cl. CPC H02K 9/223; H02K 11/25; H02K 1/146

(57) ABSTRACT

A motor structure includes a housing, a stator winding and at least one thermal conductive pad. The housing includes an internal space. The stator winding is received in the internal space. The at least one thermal conductive pad is abutted against the stator winding. The heat of the stator winding can be transmitted by the at least one thermal conductive pad.

### RELATED APPLICATIONS

This application claims priority to Taiwan Application Serial Number 109114613, filed Apr. 30, 2020, which is herein incorporated by reference.

### BACKGROUND

### Technical Field

The present disclosure relates to a motor structure. More particularly, the present disclosure relates to a motor structure facilitating for heat dissipation of a stator winding.

### Description of Related Art

A conventional motor structure includes a stator, a rotor and a stator winding. The stator winding is wound around the stator. Through the current provided by the stator winding, a phase changing effect for rotating the rotor can be achieved. However, because the heat is generated after the stator winding is powered, if the heat cannot be dissipated efficiently, the efficiency of the motor will be decreased.

In order to lower the heat generated by the stator winding, some practitioners inject a thermal conductive material, such as the epoxy resin, the synthetic resin and the thermosetting plastics, into the space between the side wall of the housing and the stator, and through the thermal conductive characteristic of the thermal conductive material filled in the gaps of the stator winding, the heat can be dissipated from the stator toward the side wall of the housing. However, the thermal conductivity of the commercial thermal conductive material is lower. The manufacturing process is complex and a baking process is required; as a result, the manufacturing difficulty and the cost are increased. In addition, the solidification shrinkage occurs when the thermal conductive material is solidified; therefore, the thermal conductive material cannot efficiently adhere between the stator and the side wall, and the heat dissipation effect becomes pool. Moreover, the housing and the stator will adhere to each other after the thermal conductive material is injected, and the disassembly and repair thereof are difficult.

Furthermore, some practitioners attach a thermal sensor to the surface of the stator winding or the gaps of the stator winding, and through detecting the temperature of the stator winding in real-time, the load of the motor can be adjusted to prevent breaking of the motor caused the overheat of the stator winding. However, it is hard to attach the thermal sensor directly to the stator winding, and rub between the thermal sensor and the rotor may happen.

Based on the above mentioned problems, how to efficiently modify the motor structure to increase the heat dissipation efficiency becomes a pursuit target for the practitioners.

### SUMMARY

According to one aspect of the present disclosure, a motor structure including a housing, a stator winding and at least one thermal conductive pad is provided. The housing includes an internal space. The stator winding is received in the internal space. The at least one thermal conductive pad is abutted against the stator winding.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of a motor structure according to one embodiment of the present disclosure.

FIG. 2 is a cross-sectional view of the motor structure of FIG. 1 taken along line 2-2.

FIG. 3 is an exploded view of the motor structure of FIG. 1.

FIG. 4 is a three-dimensional schematic view of a motor structure according to another embodiment of the present disclosure.

FIG. 5 is an exploded view of the motor structure of FIG. 4.

FIG. 6 is a cross-sectional view of the motor structure of FIG. 4 taken along line 6-6.

FIG. 7 is a partial three-dimensional schematic view of the motor structure of FIG. 4.

FIG. 8 is a partial exploded view of the motor structure of FIG. 4.

FIG. 9 is a partial three-dimensional schematic view of a motor structure according to yet another embodiment of the present disclosure.

### DETAILED DESCRIPTION

It will be understood that when an element (or mechanism or module) is referred to as being “disposed on”, “connected to” or “coupled to” another element, it can be directly disposed on, connected or coupled to the other elements, or it can be indirectly disposed on, connected or coupled to the other elements, that is, intervening elements may be present. In contrast, when an element is referred to as being “directly disposed on”, “directly connected to” or “directly coupled to” another element, there are no intervening elements present.

In addition, the terms first, second, third, etc. are used herein to describe various elements or components, and these elements or components should not be limited by these terms. Consequently, a first element or component discussed below could be termed a second element or component.

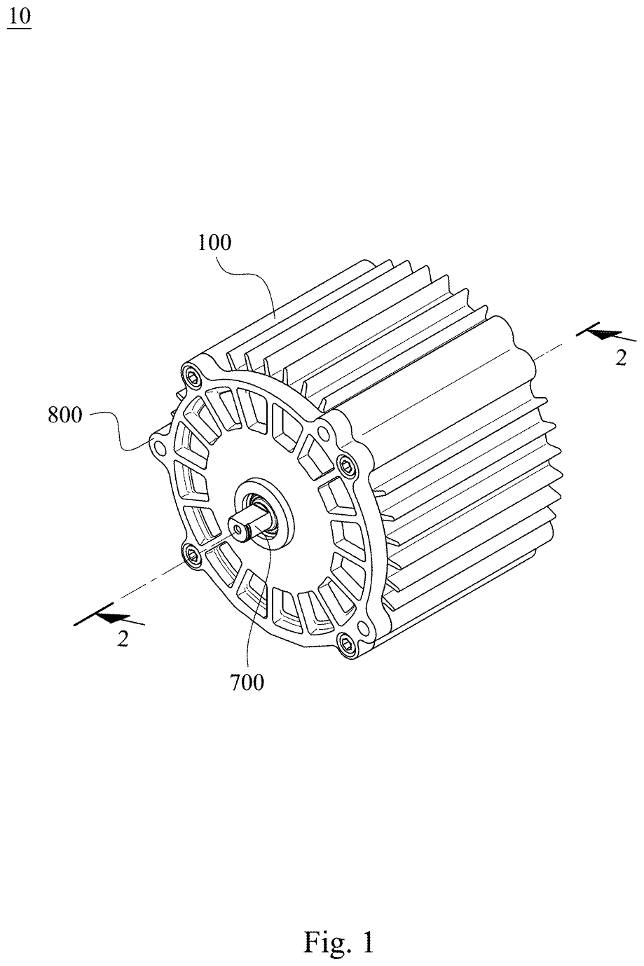

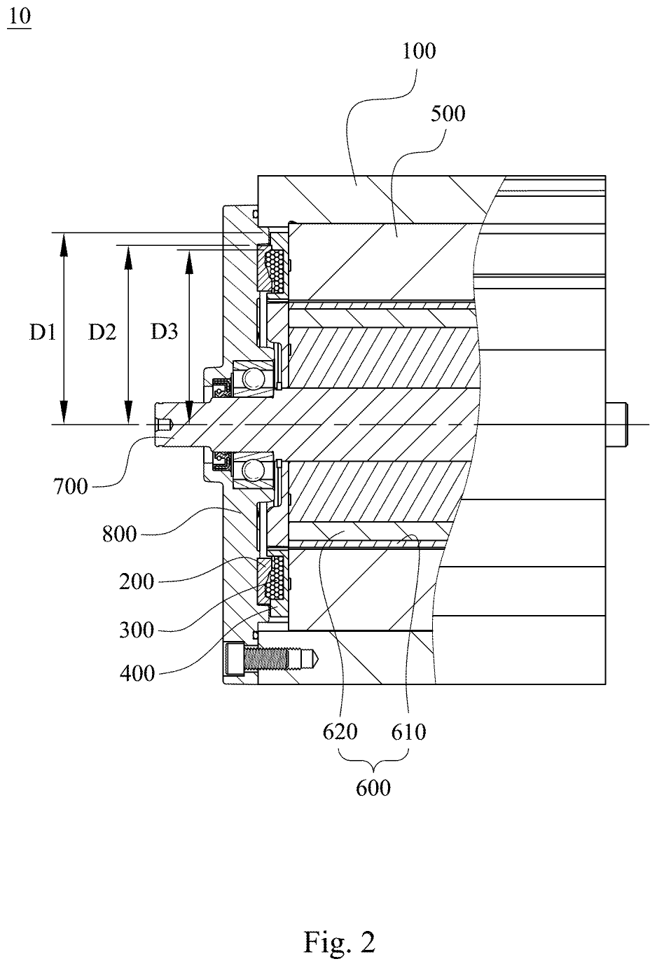

FIG. 1 is a three-dimensional schematic view of a motor structure 10 according to one embodiment of the present disclosure. FIG. 2 is a cross-sectional view of the motor structure 10 of FIG. 1 taken along line 2-2. As shown in FIGS. 1 and 2, the motor structure 10 includes a housing 100, a stator winding 300 and at least one thermal conductive pad 200. The housing 100 includes an internal space (not labeled in FIGS. 1 and 2). The stator winding 300 is received in the internal space. The at least one thermal conductive pad 200 is abutted against the stator winding 300.

Therefore, the heat of the stator winding 300 can be transmitted by the thermal conductive pad 200, and the heat dissipation effect can be increased. The motor structure 10 will be described in detail hereinafter.

The housing 100 of the motor structure 10 is hollow cylinder-shaped and has the internal space. The motor structure 10 can further include a shaft 700, a rotor 600, a stator 500 and a winding seat 400. The shaft 700 is located within the internal space. The rotor 600 sleeves on an outside of the shaft 700 and includes a rotor silicon steel core 610 and a plurality of rotor magnets 620. The rotor magnets 620 are respectively inserted in a plurality of slots of the rotor silicon steel core 610. The stator 500 is located within the internal space and sleeves on an outside of the rotor silicon steel core 610. The winding seat 400 can be disposed at one end of the stator 500, and at least one wire (not shown in FIGS. 1 and 2) of the stator winding 300 can be wound around the winding seat 400 and the stator 500. The shaft 700, the rotor 600 and the stator 500 are conventional and are not key features of the present disclosure; hence, the details thereof will not be mentioned. The motor structure 10 can further include an end cap 800. The end cap 800 is connected to one end of the housing 100, and the at least one thermal conductive pad 200 is located between the stator winding 300 and the end cap 800.

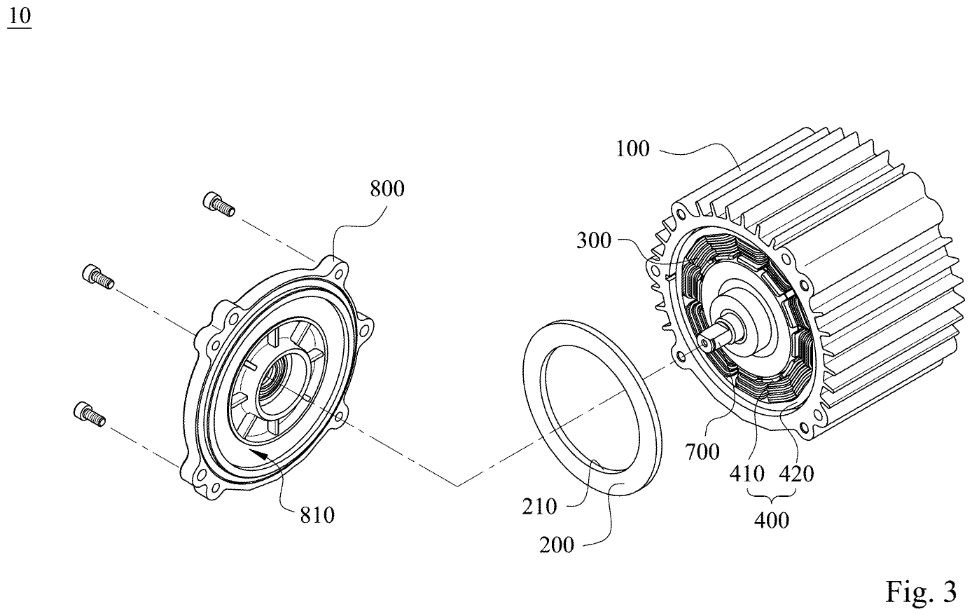

FIG. 3 is an exploded view of the motor structure 10 of FIG. 1. Please refer to FIG. 3 with reference to FIG. 2. A number of the at least one thermal conductive pad 200 is one and the thermal conductive pad 200 is ring-shaped. The thermal conductive pad 200 includes a central hole 210. After the shaft 700, the rotor 600, the stator winding 300, the stator 500 and the winding seat 400 are assembled in the internal space, the thermal conductive pad 200 can be disposed thereon to abut against the stator winding 300. The central hole 210 of the thermal conductive pad 200 is configured for the shaft 700 to protrude therefrom.

The winding seat 400 can include an annular frame 420 and at least one winding post 410 protruding radially and inwardly from the annular frame 420. The at least one wire is wound around the at least one winding post 410 and the stator 500. The annular frame 420 can have an outer radius D1, the thermal conductive pad 200 can have an outer radius D2, and the outer radius D1 of the annular frame 420 is larger than the outer radius D2 of the thermal conductive pad 200. The annular frame 420 can have an inner radius D3, and the inner radius D3 of the annular frame 420 is smaller than the outer radius D2 of the thermal conductive pad 200. Consequently, as the thermal conductive pad 200 is disposed on the stator winding 300, a part of the thermal conductive pad 200 can be abutted against a surface of the winding seat 400, that is, abutted against partial of a surface of the annular frame 420. Because a part of the heat generated by the stator winding 300 will be transmitted to the winding seat 400, the heat dissipation capability can be increased as the thermal conductive pad 200 abutted against the stator winding 300 and the winding seat 400 simultaneously.

In addition, the thermal conductive pad 200 can have a thermal conductivity ranged from 1.5 W/m·K to 17 W/m·K. In consideration of both of the cost and the heat conduction capability, the thermal conductivity can be ranged from 2 W/m·K to 4 W/m·K. Therefore, the thermal conductive pad 200 has a good dissipation capability to transmit the heat from the stator winding 300 to the end cap 800. A material of the thermal conductive pad 200 can be conductive silicone rubber. In other embodiments, the thermal conductive pad can be a non-silicone conductive pad, and can be made from any flexible conductive material.

As shown in FIGS. 2 and 3, the end cap 800 can include an annular groove 810 facing toward the stator winding 300, and the thermal conductive pad 200 can be restricted by the annular groove 810. The shape of the thermal conductive pad 200 can be correspondent to the shape of the annular groove 810. Hence, when the end cap 800 is assembled with the housing 100, the thermal conductive pad 200 will protrude into the annular groove 810 so as to be positioned by the annular groove 810. As a result, the thermal conductive pad 200 can be positioned, and a displacement of the thermal conductive pad 200 can be avoided, thereby increasing the structure stability thereof.

There is no thermal conductive pad disposed between the end cap and the stator winding for a conventional motor structure, and, instead, an air gap is contained therebetween. Because the heat conductive effect of the air is poor, the heat cannot be dissipated efficiently. Hence, through containing an isolated thermal conductive pad with high thermal conductivity between the end cap and the stator winding, the heat of the stator winding can be transmitted to the end cap, thereby facilitating the heat dissipation. Additionally, since the thermal conductive pad is detachably assembled between the end cap and the stator winding, repairs to the motor structure will not be affected, and the usage convenience can be increased.

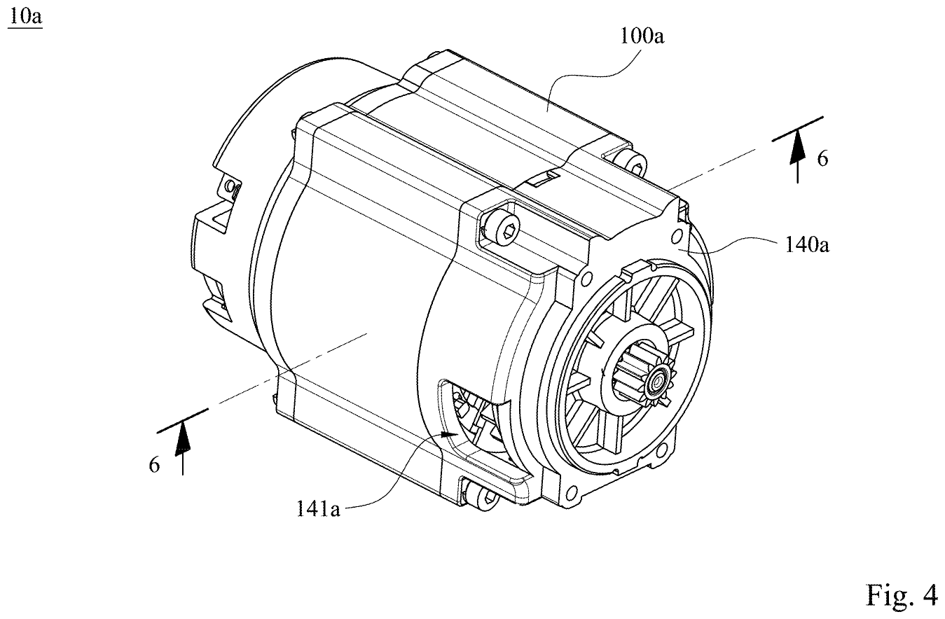

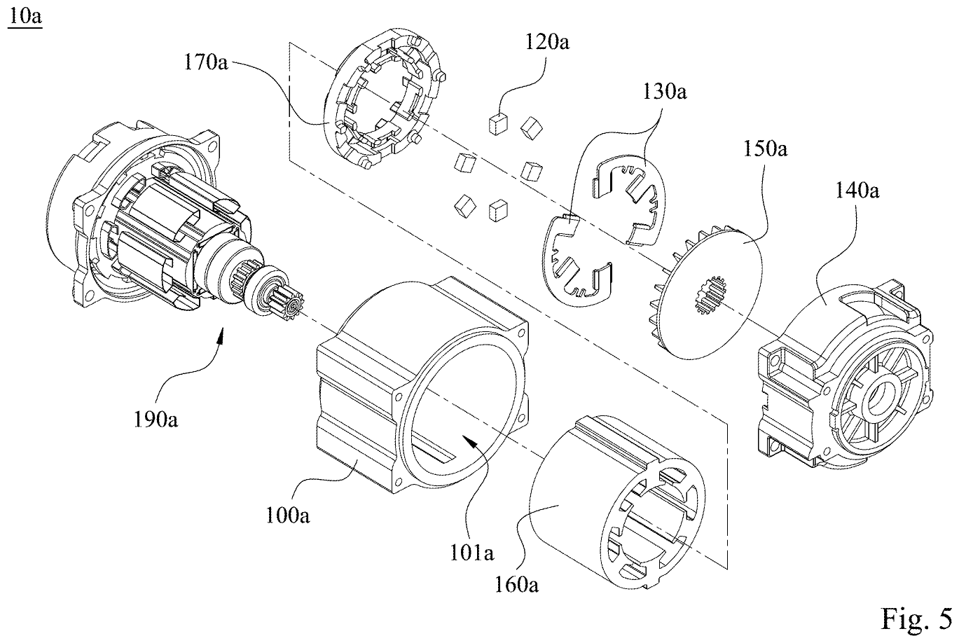

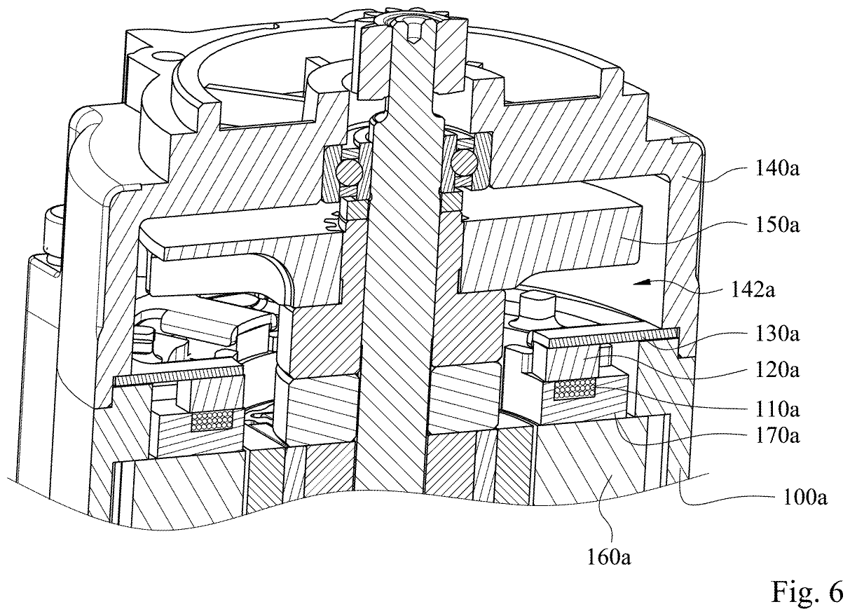

FIG. 4 is a three-dimensional schematic view of a motor structure 10a according to another embodiment of the present disclosure. FIG. 5 is an exploded view of the motor structure 10a of FIG. 4. FIG. 6 is a cross-sectional view of the motor structure 10a of FIG. 4 taken along line 6-6. As shown in FIGS. 4 to 6, the motor structure 10a includes a housing 100a, a stator winding 110a, at least one thermal conductive pad 120a and at least one thermal conductive sheet 130a. The housing 100a includes an internal space 101a. The stator winding 110a is received in the internal space 101a. The at least one thermal conductive pad 120a is abutted against the stator winding 110a. The thermal conductive sheet 130a is abutted against the at least one thermal conductive pad 120a.

Through the configuration that the thermal conductive sheet 130a is abutted against the thermal conductive pad 120a, the heat generated from the stator winding 110a can be dissipated via the thermal conductive pad 120a and the thermal conductive sheet 130a, and overheat of the stator winding 110a can be avoided. In other embodiments, the material of the thermal conductive sheet can be a composite material, and the present disclosure is not limited thereto.

A material of the thermal conductive sheet 130a can be a metal, such as aluminum and copper, whose thermal conductivity is high. The thermal conductivity for example can be ranged from 80 W/m-K to 400 W/m-K, which facilitates increasing the rate of the heat conduction.

Compared to heat convection and heat radiation, heat conduction is a faster heat transmitting method. Because one surface of the thermal conductive pad 120a is abutted against the stator winding 110a and the other surface of the thermal conductive pad 120a is abutted against the thermal conductive sheet 130a, the heat generated by the stator winding 110a after powered will be directly and quickly transmitted to the thermal conductive pad 120a, and then be directly and quickly transmitted to the housing 100a via the thermal conductive sheet 130a.

As shown in FIG. 4, the end cap 140a of the motor structure 10a can be abutted against the housing 100a to press the thermal conductive sheet 130a such that the thermal conductive sheet 130a, the thermal conductive pad 120a and the housing 100a can be contacted to each other; as a result, the thermal conductive pad 120a can be tightly contacted to the stator winding 110a. Moreover, after the end cap 140a and the housing 100a are assembled, a receiving space 142a can be formed and configured to accommodate a circuit board or other components. In the embodiment of FIGS. 4 to 6, the receiving space 142a is configured to accommodate a fan 150a. The fan 150a and the rotor 190a are coaxially arranged and can be rotated with the rotor 190a. The end cap 140a can further include at least one heat dissipating aperture 141a. The heat generated by the stator winding 110a in operation can be transmitted through the thermal conductive pad 120a to the thermal conductive sheet 130a by the heat conduction. One part of the heat will be transmitted to the end cap 140a and the housing 100a by the heat conductive while the other part of the heat can leave the thermal conductive sheet 130a by the heat convection owing to the rotation of the fan 150a and can be dissipated via the heat dissipating aperture 141a to the outer of the motor structure 10a.

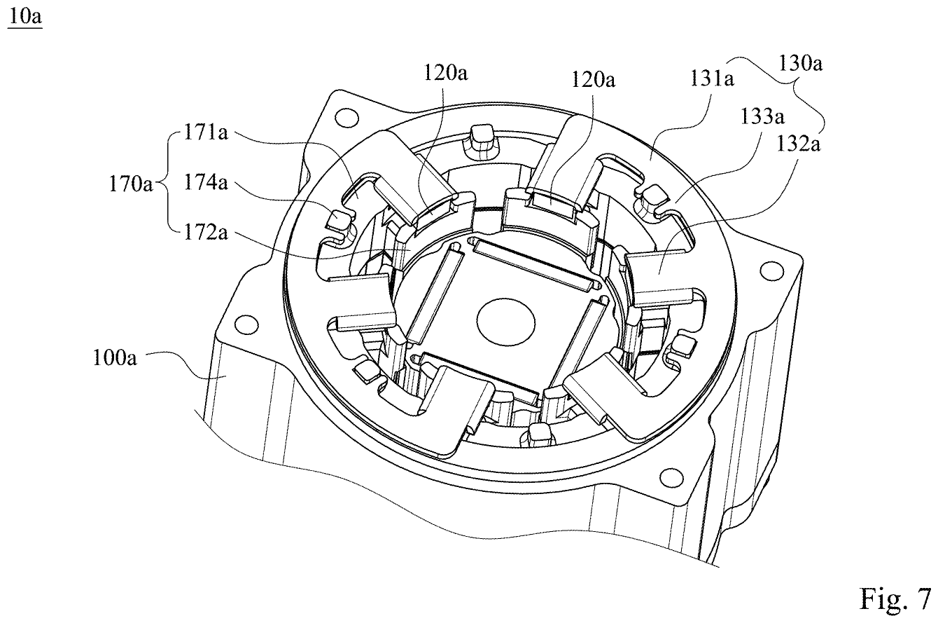

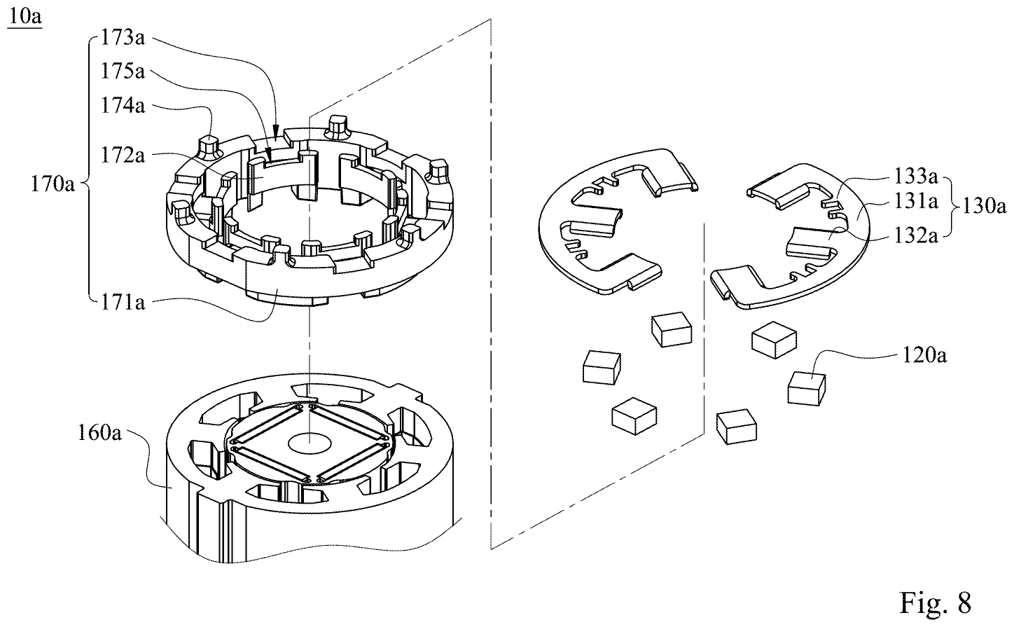

FIG. 7 is a partial three-dimensional schematic view of the motor structure 10a of FIG. 4. FIG. 8 is a partial exploded view of the motor structure 10a of FIG. 4. As shown in FIGS. 7 and 8, the motor structure 10a can further include a winding seat 170a and a stator 160a. The winding seat 170a includes an annular frame 171a and at least one winding post 172a. The winding seat 170a can further include a first receiving groove 173a and a second receiving groove 175a. The first receiving groove 173a is located on the annular frame 171a. The second receiving groove 175a is located on the winding post 172a. The first receiving groove 173a is radially correspondent to the second receiving groove 175a. As the thermal conductive pad 120a is disposed on the winding seat 170a, one end of the thermal conductive pad 120a is received in the first receiving groove 173a and the other end of the thermal conductive pad 120a is received in the second receiving groove 175a. Based on the configuration, when the thermal conductive pad 120a is deformed owing to the push of the thermal conductive sheet 130a, the first receiving groove 173a and the second receiving groove 175a can provide sufficient deformation spaces, and the central segment of the thermal conductive pad 120a can be abutted against the stator winding 110a tightly. However, the present disclosure is not limited by the size or shape of each of the first receiving groove 173a and the second receiving groove 175a. A number of the thermal conductive pads 120a, a number of the winding posts 172a, a number of the first receiving grooves 173a and a number of the second receiving grooves 175a are all more than three and are the multiples of three. There are six thermal conductive pads 120a, six winding posts 172a, six first receiving grooves 173a and six second receiving grooves 175a in the embodiment, but the amount thereof can be changed to three, nine or twelve based on the demands. In other embodiment, the thermal conductive pad can be a one-piece element which is ring-shaped and is abutted against each wire of the stator winding, and the thermal conductive pad can include at least one opening configured for the air to flow therethrough. In such configuration, the first receiving groove and the second receiving groove can be omitted, but the present disclosure is not limited thereto.

The thermal conductive sheet 130a of the motor structure 10a includes a thermal conductive sheet body 131a and at least one pressing portion 132a. The at least one pressing portion 132a protrudes radially and inwardly from the thermal conductive sheet body 131a, and the at least one pressing portion 132a is configured to press the thermal conductive pad 120a to cause the deformation of the thermal conductive pad 120a. During a manufacturing process of the pressing portion 132a, a projection can be formed by bending the thermal conductive sheet body 131a toward the thermal conductive pad 120a, which, on one hand, can restrict the thermal conductive pad 120a in association with the first receiving groove 173a and the second receiving groove 175a to prevent the thermal conductive pad 120a from separating therefrom, and, on the other hand, the structure strength of the pressing portion 132a is increased, thereby preventing the pressing portion 132a from being deformed by pushing by the restoring force of the thermal conductive pad 120a.

The thermal conductive sheet 130a can further include at least one engaging portion 133a disposed on the thermal conductive sheet body 131a. The winding seat 170a can further include at least one engaging projection 174a, and the at least one engaging portion 133a is correspondent to the at least one engaging projection 174a. The shape of the engaging portion 133a can match the shape of the engaging projection 174a. As shown in FIG. 7, each of the engaging portions 133a includes two clamping arms protruding radially from the thermal conductive sheet body 131a. An aperture is formed between the two protruding clamping arms and is configured for the engaging projection 174a to be engaged therewith. Therefore, the thermal conductive sheet 130a can be positioned by the winding seat 170a. In other embodiment, the engaging portion and the engaging projection are cooperated in other ways.

As shown in the embodiment of FIGS. 7 and 8, a number of the thermal conductive sheets 130a can be two. Each of the pressing portions 132a is correspondent to each of the winding posts 172a. The number of the pressing portions 132a is correspondent to the number of the winding posts 172a, which is also correspondent to the number of the wires of the stator winding 110a. In the embodiment, the number of the winding posts 172a is six, the number of the wires of the stator winding 110a is six, and the number of the pressing portions 132a is also six to ensure that the heat of each of the wires can be transmitted by the thermal conductive pad 120a and the thermal conductive sheet 130a. In other embodiments, the number of the thermal conductive sheets and the number of the pressing portions can be varied based on the number of the winding posts. For example, as the number of the winding posts is nine, the number of the thermal conductive sheets can be three and the number of the pressing portions can be three. As the number of the winding posts is twelve, the number of the thermal conductive sheets and the number of the pressing portions can be two and six, respectively, or can be three and four, respectively, and the present disclosure is not limited thereto.

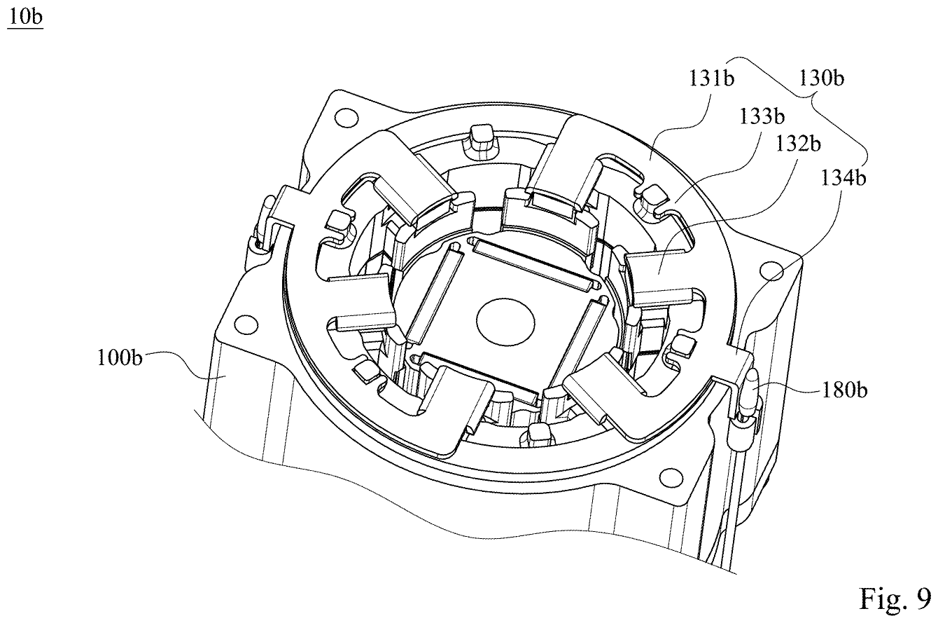

FIG. 9 is a partial three-dimensional schematic view of a motor structure 10b according to yet another embodiment of the present disclosure. As shown in FIG. 9, the motor structure 10b is similar to the motor structure 10a but can further include at least one thermal sensor 180b connected to the at least one thermal conductive sheet 130b. Precisely, the thermal conductive sheet 130b is similar to the thermal conductive sheet 130a and includes a thermal conductive sheet body 131b, a pressing portion 132b and an engaging portion 133b. The difference is that the thermal conductive sheet 130b can further include at least one extending portion 134b. The extending portion 134b which protrudes outwardly form the thermal conductive sheet body 131b is exposed from the housing 100b and is configured to connect to the thermal sensor 180b. In the embodiment of FIG. 9, a number of the thermal conductive sheets 130b, a number of the extending portions 134b and a number of the thermal sensors 180b are all two. Through the configuration that the real-time temperature of the thermal conductive sheet 130b can be detected by the thermal sensor 180b, the corresponding temperature of the stator winding in operation can be known. Consequently, the operation mode of the motor can be changed or the motor can be stopped by the controller to lower the temperature of the stator winding. Moreover, since the thermal sensor 180b is disposed outside the housing 100b, the assembly thereof is convenient, and the abnormal operation caused by the wrong assembly can be avoided. In other embodiments, the number of the thermal conductive sheets, the number of the extending portions, the number of thermal sensors, the positions of the thermal conductive sheets, the positions of the extending portions and the positions of thermal sensors can be changed based on the actual volume or phase requirements of the motor, and the present disclosure is not limited thereto.

Based on the above mentioned embodiments, it is known that through the configuration that the thermal conductive pad is directly abutted against the stator winding and the thermal conductive sheet is directly abutted against the thermal conductive pad, the heat of the stator winding in operation can be transmitted by the heat conduction. Moreover, in association with the heat convection of the fan, the heat dissipation effect can be increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A motor structure, comprising:
a housing, comprising an internal space;
a stator winding received in the internal space; and
at least one thermal conductive pad abutted against the stator winding.

2. The motor structure of claim 1, further comprising:
a stator located within the internal space; and
a winding seat disposed at one end of the stator and comprising:
an annular frame; and
at least one winding post protruding radially and inwardly from the annular frame;
wherein at least one wire of the stator winding is wound around the at least one winding post and the stator, and the at least one thermal conductive pad is abutted against the at least one wire.

3. The motor structure of claim 2, further comprising:
an end cap connected to one end of the housing;
wherein the at least one thermal conductive pad is located between the stator winding and the end cap.

4. The motor structure of claim 3, wherein a number of the at least one thermal conductive pad is one and the thermal conductive pad is ring-shaped.

5. The motor structure of claim 4, wherein the annular frame has an outer radius, the thermal conductive pad has an outer radius, and the outer radius of the annular frame is larger than the outer radius of the thermal conductive pad.

6. The motor structure of claim 5, wherein the annular frame has an inner radius, and the inner radius of the annular frame is smaller than the outer radius of the thermal conductive pad.

7. The motor structure of claim 4, wherein the end cap comprises an annular groove facing toward the stator winding, and the thermal conductive pad is restricted by the annular groove.

8. The motor structure of claim 1, further comprising:
at least one thermal conductive sheet abutted against the at least one thermal conductive pad.

9. The motor structure of claim 8, further comprising:
a stator located within the internal space; and
a winding seat disposed at one end of the stator and comprising:
an annular frame; and
at least one winding post protruding radially and inwardly from the annular frame;
wherein at least one wire of the stator winding is wound around the at least one winding post and the stator, and the at least one thermal conductive pad is abutted against the at least one wire.

10. The motor structure of claim 9, wherein a material of the at least one thermal conductive sheet is metal.

11. The motor structure of claim 9, further comprising:
an end cap connected to one end of the housing, wherein a receiving space is formed between the end cap and the at least one thermal conductive sheet.

12. The motor structure of claim 9, wherein the at least one thermal conductive sheet comprises:
a thermal conductive sheet body; and
at least one pressing portion protruding radially and inwardly from the thermal conductive sheet body, the at least one pressing portion configured to press the at least one thermal conductive pad.

13. The motor structure of claim 12, wherein the at least one pressing portion is correspondent to the at least one winding post, and a number of the at least one pressing portion is correspondent to a number of the at least one winding post.

14. The motor structure of claim 12, wherein the at least one thermal conductive sheet further comprises at least one engaging portion disposed on the thermal conductive sheet body, the winding seat further comprises at least one engaging projection, and the at least one engaging portion is correspondent to the at least one engaging projection.

15. The motor structure of claim 8, further comprising:
at least one thermal sensor connected to the at least one thermal conductive sheet.

16. The motor structure of claim 1, wherein the at least one thermal conductive pad has a thermal conductivity ranged from 1.5 W/m·K to 17 W/m·K.
